(19) United States
(12) Patent Application Publication
(10) Pub. No.: US 2026/0284451 A1
(43) Pub. Date: Sep. 24, 2026

(54) LIFELINE ARRANGMENT

(71) Applicant: SAFEHOLD LIMITED, Canterbury (GB)

(72) Inventor: Oliver Auston, Canterbury (GB)

(73) Assignee: SAFEHOLD LIMITED, (omitted)

(21) Appl. No.: 19/479,534

(22) PCT Filed: Apr. 29, 2024
(86) PCT No.: PCT/GB2024/051132

§ 371 Date: Oct. 28, 2025

(30) Foreign Application Priority Data
Apr. 28, 2023 (GB) 2306360.5

(51) Int. Cl. A62B 35/00

(52) U.S. Cl. CPC A62B 35/0093; A62B 35/0037; A62B 35/0056; A62B 35/0068

(57) ABSTRACT

A lifeline arrangement comprising a lifeline and a tensioner for the lifeline, wherein the lifeline tensioner includes: a housing; a pulley disposed within the housing, wherein the pulley is connected to a drive shaft and rotation of the drive shaft results in rotation of the pulley, the pulley defines a circumferential channel, and the drive shaft and pulley rotate relative to the housing about a first axis; a portion of the lifeline is located within a portion of the circumferential channel; a lifeline locking element including a lifeline engagement portion and an anchor portion, wherein the lifeline engagement portion has an engaged configuration in which it engages a portion of the lifeline within the circumferential channel, and a release configuration in which it is spaced from the lifeline, the lifeline engagement portion in its engaged configuration permits displacement of the lifeline in a tensioning direction, but prevents displacement of the lifeline in a loosening direction, and a connector is connected to the anchor portion; and wherein an operating wheel is connected to the drive shaft; and/or wherein a tension indicator is located between the connector and the anchor portion, wherein the tension indicator senses a tensile force applied to the lifeline and indicates if the sensed tensile force is within a pre-determined range; and/or wherein a distal end of the lifeline includes a swivel.

A horizontal lifeline arrangement is commonly used to interconnect two anchor points, and user(s) connect to and move along the lifeline as they perform tasks proximate the anchor points. Example anchor points include stanchions but other anchor structures could be used. Typically, a user dons a safety harness and a lanyard interconnects the safety harness and the lifeline. The lanyard could be an energy absorbing lanyard. Some horizontal lifeline assemblies allow up to four users to be connected to the lifeline. To reduce the risk of injury should a fall occur, it is important to tension the lifeline properly, and a tensioner is commonly used. It is desired to provide a tensioner that is both easy to use and to administer a desired tension.

Horizontal lifeline arrangements are known. For example, WO2018/033729 describes a horizontal lifeline arrangement. However, the arrangement shown WO2018/033729 may be difficult to use, does not sense the tension in the lifeline as a tensile force is applied to it and may suffer from twists in the lifeline which can alter or change the applied tension.

One or more of the above-mentioned problems associated with prior devices may be addressed by embodiments of the present invention as claimed.

According to a first aspect of the invention, there is provided a lifeline arrangement comprising a lifeline and a tensioner for the lifeline, wherein the lifeline tensioner includes: a housing; a pulley disposed within the housing, wherein the pulley is connected to a drive shaft and rotation of the drive shaft results in rotation of the pulley, the pulley defines a circumferential channel, and the drive shaft and pulley rotate relative to the housing about a first axis; a portion of the lifeline is located within a portion of the circumferential channel; a lifeline locking element including a lifeline engagement portion and an anchor portion, wherein the lifeline engagement portion has an engaged configuration in which it engages a portion of the lifeline within the circumferential channel, and a release configuration in which it is spaced from the lifeline, the lifeline engagement portion in its engaged configuration permits displacement of the lifeline in a tensioning direction, but prevents displacement of the lifeline in a loosening direction, and a connector is connected to the anchor portion; and wherein an operating wheel is operatively connected to the drive shaft.

It will be appreciated that an operating wheel provides an easier and more intuitive component via which the lifeline may be tensioned. Rotation of the operating wheel in a tensioning direction or sense causes rotation of the drive shaft. Thus, the operating wheel is rotationally fixed relative to the drive shaft, at least in the tensioning direction or sense. As noted above, the rotation of the drive shaft causes a consequential rotation of the pulley, which in turn tensions the lifeline. In other words, the lifeline tensioner applies a tensile force to the lifeline.

In an embodiment of the invention, the drive shaft extends through a portion of the housing and the operating wheel is located externally of the housing. Thus, the pulley is located within the housing and the operating wheel is suitably located outside of the housing. The location of the operating wheel outside of the housing permits easier access to the operating wheel for a user.

Suitably, the operating wheel is connected to the drive shaft via a clutch, wherein rotation of the operating wheel in a first direction or sense (i.e., a tensioning direction or sense) causes the drive shaft to rotate, and rotation of the operating wheel in a second, opposite direction or sense causes the operating wheel to rotate relative to the drive shaft. In such embodiments, the pulley only rotates when the operating wheel is rotated in the tensioning (first) direction or sense. The pulley remains stationary when the operating wheel is rotated in the opposite direction or sense. Thus, the clutch may be considered in this embodiment to be a one-way clutch.

The clutch may be a two-part clutch, wherein a first part of the clutch is rotationally fixed to the drive shaft and a second part of the clutch is rotationally fixed to the operating wheel; and wherein the second part of the clutch engages the first part of the clutch when the operating wheel is rotated in the first direction, and wherein the second part of the clutch slips relative to the first part of the clutch when the operating wheel is rotated in the second direction.

For example, at least one of the first and second parts of the clutch may define teeth, wherein each of the teeth has an engagement face and a sloped slip face. In such embodiments, an engagement element may engage the engagement face, which allows that part of the clutch to be driven to rotate. However, when rotated in the opposite direction, the engagement element engages the sloped slip face, which causes the engagement element to rotate relative to that part of the clutch.

In an embodiment of the invention, both the first and second parts of the clutch define teeth, wherein each of the teeth defines an engagement face and a sloped slip face. In such embodiments, the two parts of the clutch are arranged such that when the operating wheel is rotated in the first or tensioning direction, the engagement face of the teeth of the first part of the clutch engage respective engagement faces of the teeth of the second part of the clutch and the rotation of the operating wheel results in a corresponding rotation of the drive shaft. However, when the operating wheel is rotated in the opposite or second direction, the sloped slip face of the teeth of the first part of the clutch engage respective sloped slip faces of the teeth of the second part of the clutch and the rotation of the operating wheel results in the first part of the clutch rotating relative to the second part of the clutch.

In a further embodiment of the invention, the lifeline tensioner further includes a release element coupled to the lifeline locking element, wherein displacement of the release element causes the lifeline locking element to move from its engaged configuration to its release configuration. Such an arrangement may make it easier to release the tension in the lifeline when it is under tension.

It will be appreciated that in use, the anchor portion connector of the lifeline tensioner is secured to a first anchor structure and one end (a distal end) of the lifeline is attached to a second anchor structure. Thus, the anchor portion connector of the lifeline tensioner is suitably configured to be secured to an anchor structure.

It will be appreciated that a tensile force applied to the anchor portion urges the lifeline engagement portion into its engaged configuration. Thus, the more tensile force applied to the anchor portion of the lifeline locking element, the greater the force that is exerted by the lifeline engagement portion on the lifeline.

The lifeline engagement portion of the lifeline locking element suitably includes teeth which engage with a portion or portions of the lifeline located within the pulley channel.

According to a second aspect of the invention, there is provided a lifeline arrangement comprising a lifeline and a tensioner for the lifeline, wherein the lifeline tensioner includes: a housing; a pulley disposed within the housing, wherein the pulley is connected to a drive shaft and rotation of the drive shaft results in rotation of the pulley, the pulley defines a circumferential channel, and the drive shaft and pulley rotate relative to the housing about a first axis; a portion of the lifeline is located within a portion of the circumferential channel; a lifeline locking element including a lifeline engagement portion and an anchor portion, wherein the lifeline engagement portion has an engaged configuration in which it engages a portion of the lifeline within the circumferential channel, and a release configuration in which it is spaced from the lifeline, the lifeline engagement portion in its engaged configuration permits displacement of the lifeline in a tensioning direction, but prevents displacement of the lifeline in a loosening direction, and a connector is connected to the anchor portion; and wherein a tension indicator is located between the connector and the anchor portion, wherein the tension indicator senses a tensile force applied to the lifeline and optionally indicates if the sensed tensile force is within a pre-determined range.

As noted above, it is desired to provide a tensile force to the lifeline which is within a pre-determined range. However, in known lifeline arrangements, the user has to guess the tension that has been applied to the lifeline. In the invention according to the second aspect of the invention, the user is able to determine the tensile force that has been applied to the lifeline.

The lifeline arrangement of the second aspect suitably further includes an operating element that is coupled to or selectively coupled to the drive shaft. The operating element may be a wheel or a lever, for example.

In an embodiment of the invention, the tension indicator includes a spring having a fixed end and a free end and the free end of the spring is displaced relative to the fixed end as a result of the tensile force within the lifeline. Thus, the free end of the spring is displaced away from the fixed end of the spring as the tensile force within the lifeline is increased.

Suitably, the tension indicator includes an indicator element which is displaced with the free end of the spring. In such embodiments, the user is able to see an indication of the force applied to the lifeline via the indicator element. For example, the tension indicator may have indicia associated with the indicator element such that the user or operator can see when a desired tension has been applied to the lifeline by the lifeline tensioner. Alternatively, the tension indicator may include a window and a user determines that the correct tension has been applied when the indicator element is visible in the window. For example, the indicator element may be an indicator arm or it may be a coloured band.

The skilled person should note that the features of the second aspect of the invention and embodiments thereof may be combined with the features of the first aspect of the invention as defined and described anywhere herein. Thus, the lifeline arrangement may include both an operating wheel and a tension indicator.

According to a third aspect of the invention, there is provided a lifeline arrangement comprising a lifeline and a tensioner for the lifeline, wherein the lifeline tensioner includes: a housing; a pulley disposed within the housing, wherein the pulley is connected to a drive shaft and rotation of the drive shaft results in rotation of the pulley, the pulley defines a circumferential channel, and the drive shaft and pulley rotate relative to the housing about a first axis; a portion of the lifeline is located within a portion of the circumferential channel; a lifeline locking element including a lifeline engagement portion and an anchor portion, wherein the lifeline engagement portion has an engaged configuration in which it engages a portion of the lifeline within the circumferential channel, and a release configuration in which it is spaced from the lifeline, the lifeline engagement portion in its engaged configuration permits displacement of the lifeline in a tensioning direction, but prevents displacement of the lifeline in a loosening direction, and a connector is connected to the anchor portion; and wherein a distal end of the lifeline includes a swivel.

The swivel prevents twists and kinks being introduced into the lifeline as it is tensioned.

Suitably, the swivel includes a lifeline connector portion which is coupled to the distal end of the lifeline, and a lifeline anchor portion which is adapted to be secured to an anchor structure; wherein the lifeline connector portion and the lifeline anchor portions together define a longitudinal axis; and wherein the lifeline connector portion is rotatably coupled to the lifeline anchor portion such that the lifeline connector portion is capable of rotating relative to the lifeline anchor portion about the longitudinal axis. Thus, the swivel permits the distal end of the lifeline to rotate relative to an anchor structure to which the distal end of the lifeline is secured via the swivel.

It will further be appreciated that the features of the third aspect of the invention and embodiments thereof may be combined with the features of the first aspect of the invention as defined and described anywhere herein and/or the second aspect of the invention as defined and described anywhere herein. Thus, the lifeline arrangement may include an operating wheel, a tension indicator, a swivel or any combinations thereof.

According to a fourth aspect of the invention, there is provided a lifeline assembly comprising a first anchor structure; a second anchor structure; and a lifeline arrangement according to the first aspect of the invention, the second aspect of the invention and/or the third aspect of the invention as defined anywhere herein, wherein the anchor portion of the lifeline locking element is fixed to the first anchor structure via the anchor connector; a distal end of the lifeline is fixed to the second anchor structure; and a desired tension is applied to the lifeline via the lifeline tensioner.

For example, the lifeline arrangement may comprise a lifeline and a tensioner for the lifeline, wherein the lifeline tensioner includes: a housing; a pulley disposed within the housing, wherein the pulley is connected to a drive shaft and rotation of the drive shaft results in rotation of the pulley, the pulley defines a circumferential channel, and the drive shaft and pulley rotate relative to the housing about a first axis; a portion of the lifeline is located within a portion of the circumferential channel; a lifeline locking element including a lifeline engagement portion and an anchor portion, wherein the lifeline engagement portion has an engaged configuration in which it engages a portion of the lifeline within the circumferential channel, and a release configuration in which it is spaced from the lifeline, the lifeline engagement portion in its engaged configuration permits displacement of the lifeline in a tensioning direction, but prevents displacement of the lifeline in a loosening direction, and a connector is connected to the anchor portion; wherein an operating wheel is connected to the drive shaft; wherein a tension indicator is located between the connector and the anchor portion, wherein the tension indicator senses a tensile force applied to the lifeline and indicates if the sensed tensile force is within a pre-determined range; and wherein a distal end of the lifeline includes a swivel.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings. The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

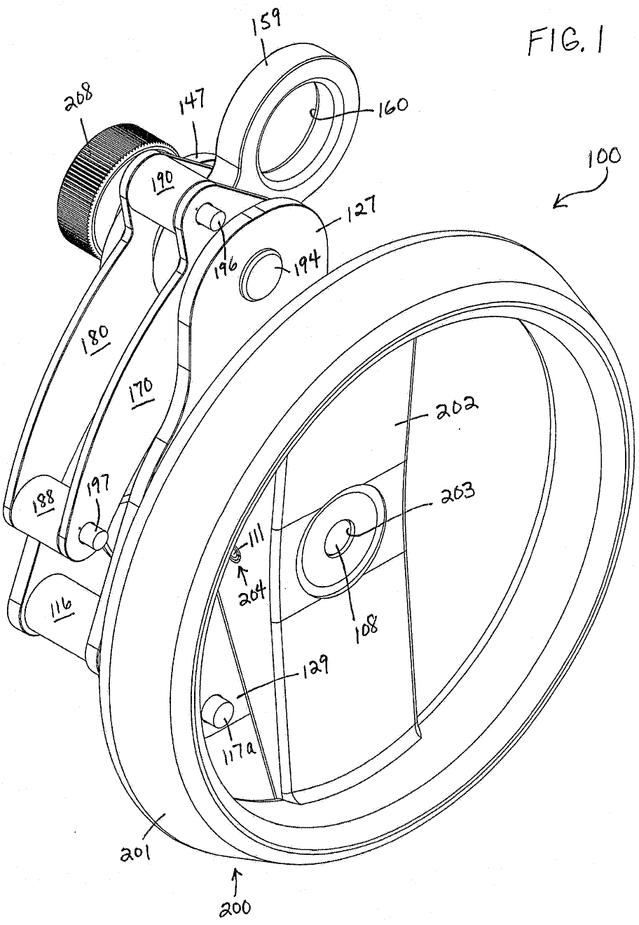

FIG. 1 is a front perspective view of a lifeline tensioner constructed in accordance with the principles of the present invention;

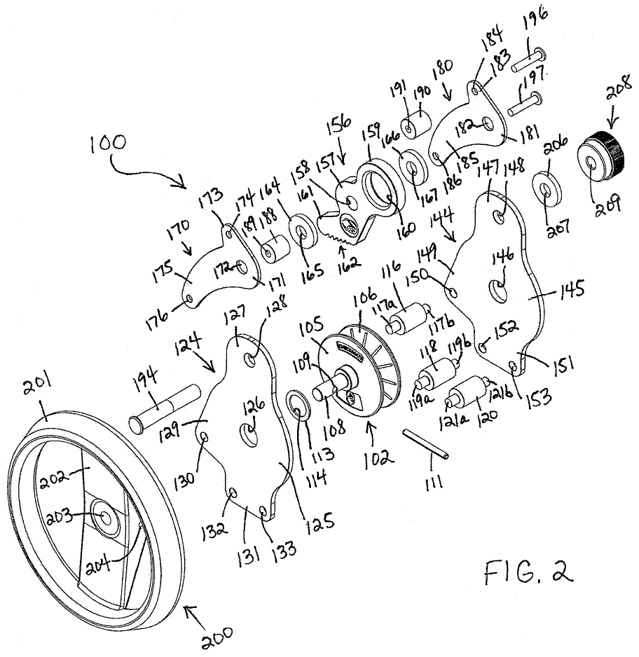

FIG. 2 is an exploded front perspective view of the lifeline tensioner shown in FIG. 1;

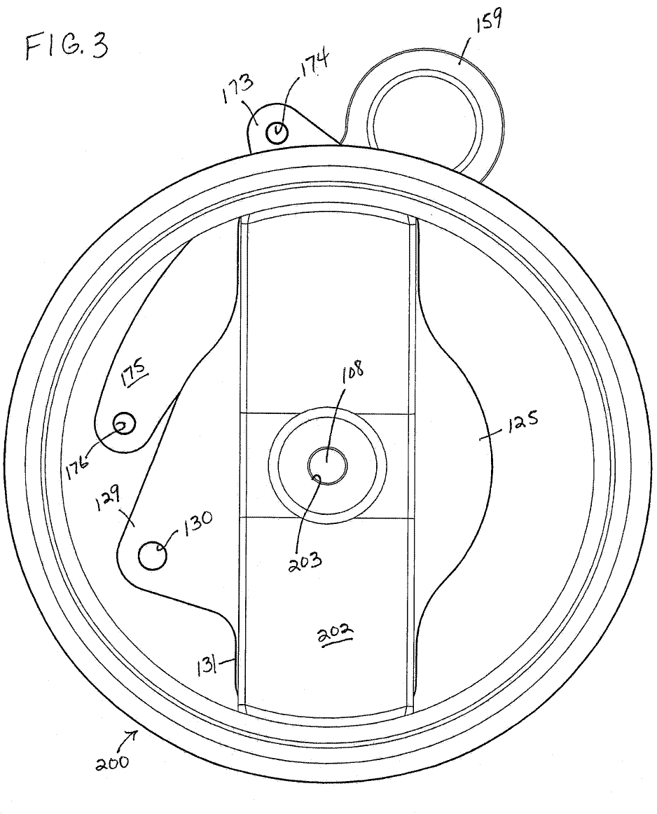

FIG. 3 is a front view of the lifeline tensioner shown in FIG. 1;

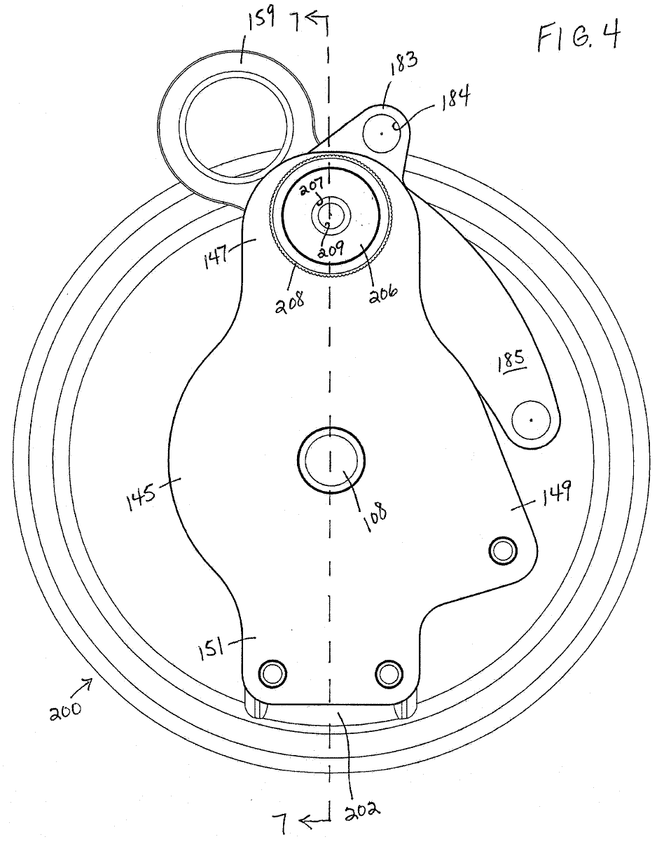

FIG. 4 is a rear view of the lifeline tensioner shown in FIG. 1;

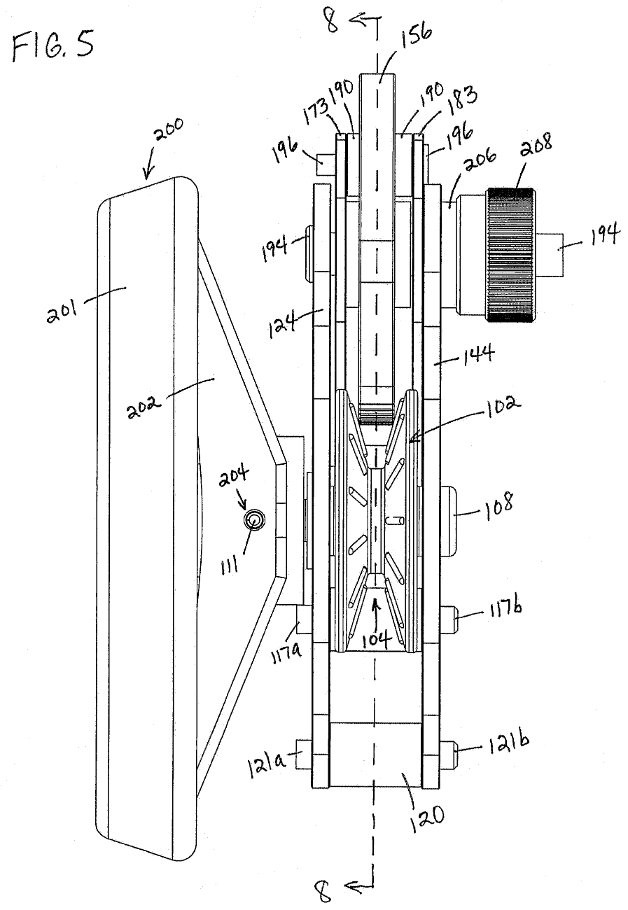

FIG. 5 is a first side view of the lifeline tensioner shown in FIG. 1;

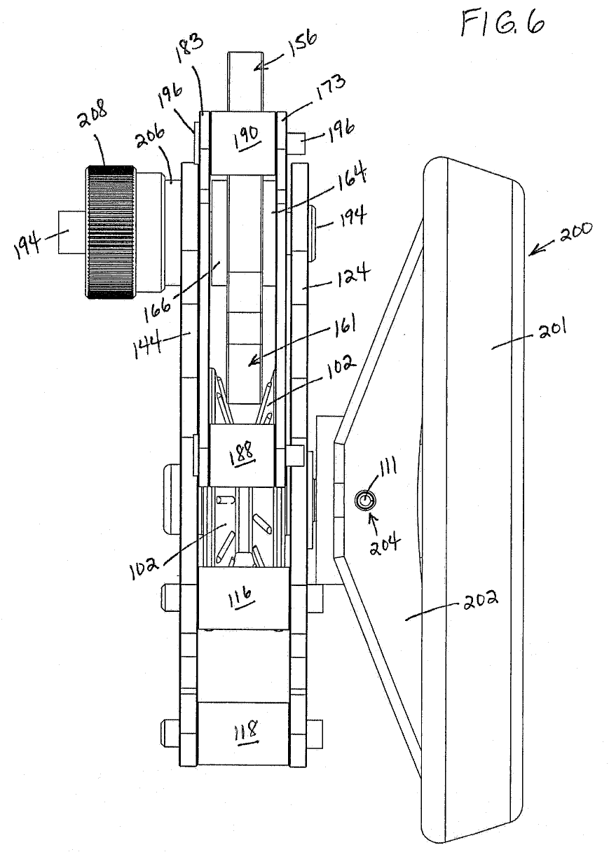

FIG. 6 is a second side view of the lifeline tensioner shown in FIG. 1;

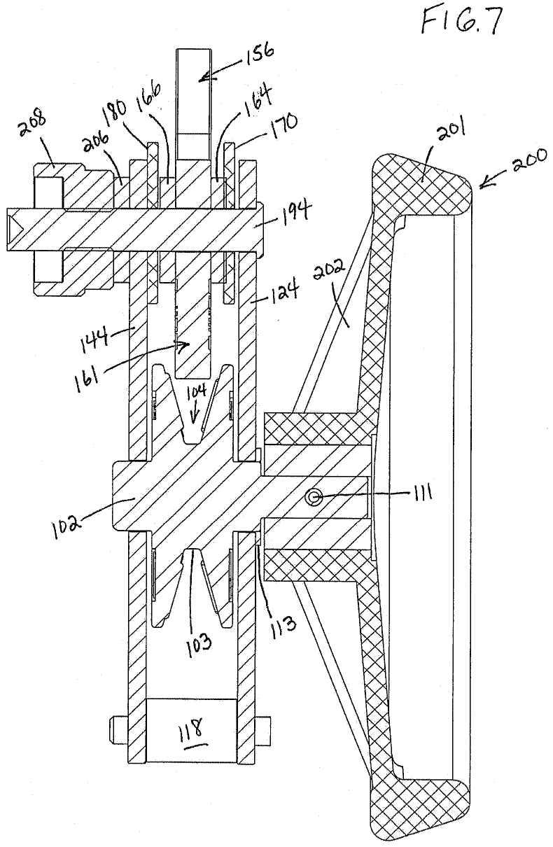

FIG. 7 is a cross section view of the lifeline tensioner shown in FIG. 1 taken along the lines 7-7 in FIG. 4;

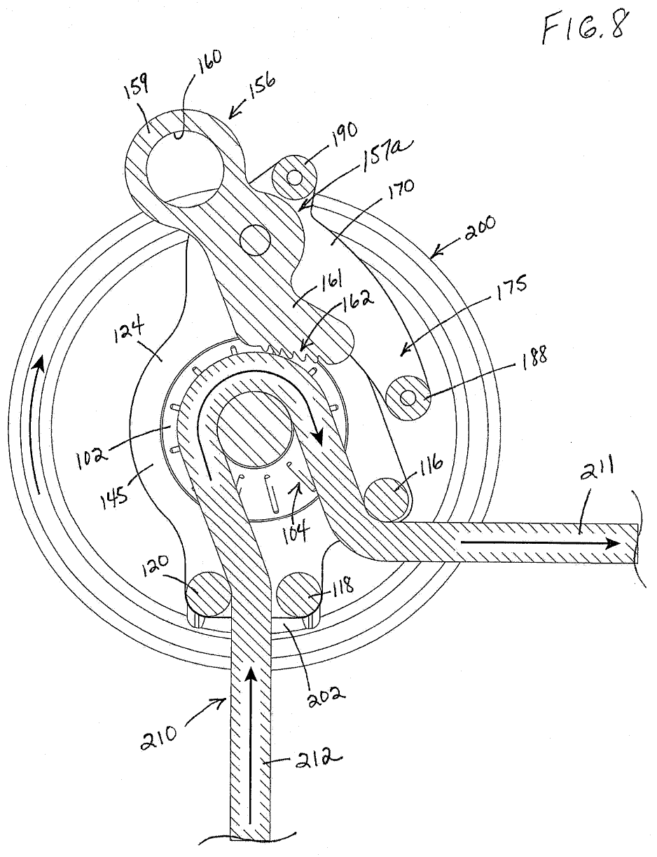

FIG. 8 is a cross section view of the lifeline tensioner shown in FIG. 1 taken along the lines 8-8 in FIG. 5;

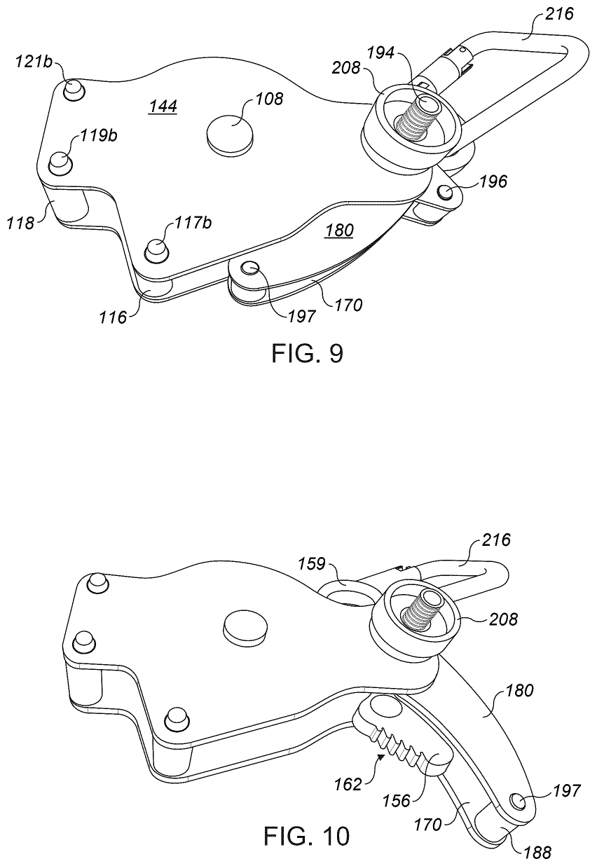

FIG. 9 is a rear view of the lifeline tensioner shown in FIG. 1 in a closed position and with a wheel removed;

FIG. 10 is a rear view of the lifeline tensioner shown in FIG. 9 in an open position and with the wheel removed;

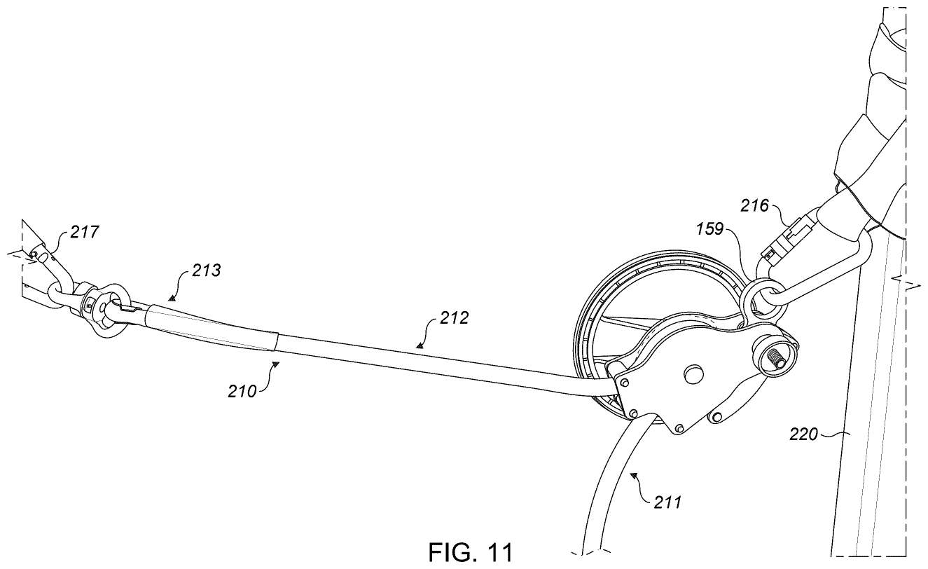

FIG. 11 is a rear view of the lifeline tensioner shown in FIG. 1 installed as part of a horizontal lifeline assembly prior to tensioning;

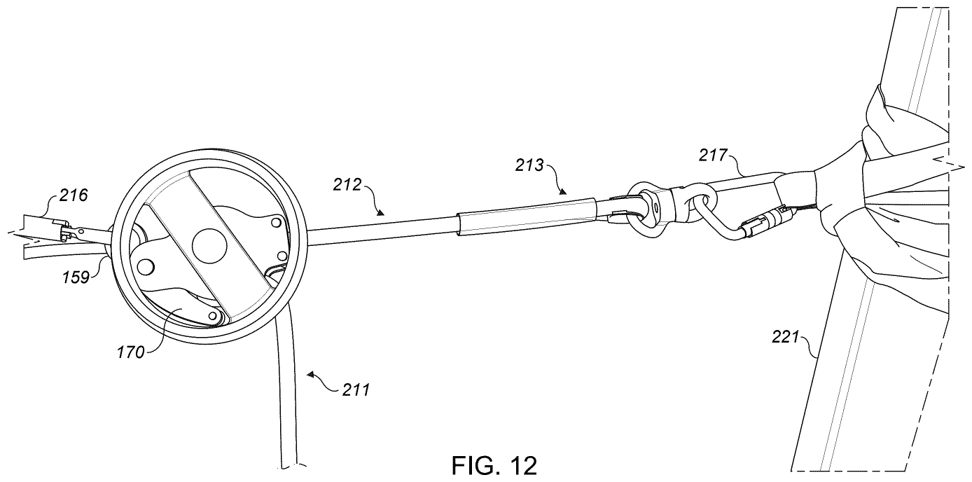

FIG. 12 is a front view of the lifeline tensioner shown in FIG. 11 installed as part of the horizontal lifeline assembly after tensioning;

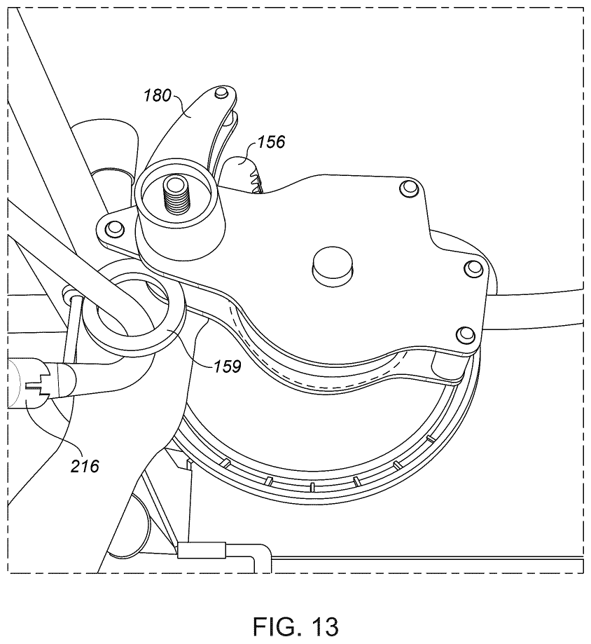

FIG. 13 is a rear view of the lifeline tensioner shown in FIG. 11 installed as part of the horizontal lifeline assembly in an open position;

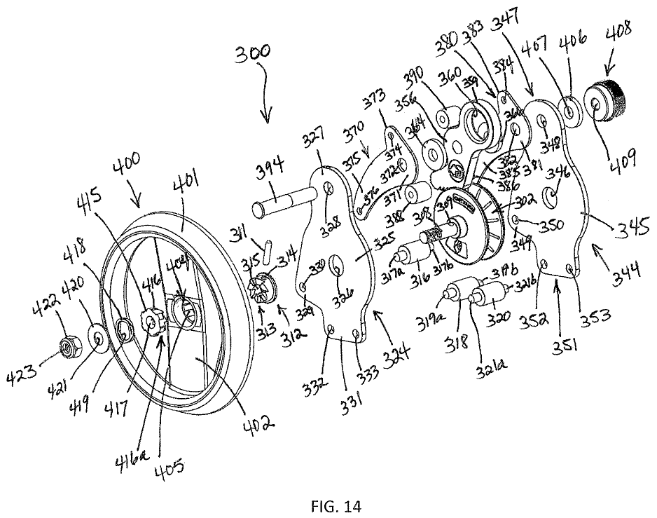

FIG. 14 is an exploded perspective view of another embodiment lifeline tensioner constructed in accordance with the principles of the present invention;

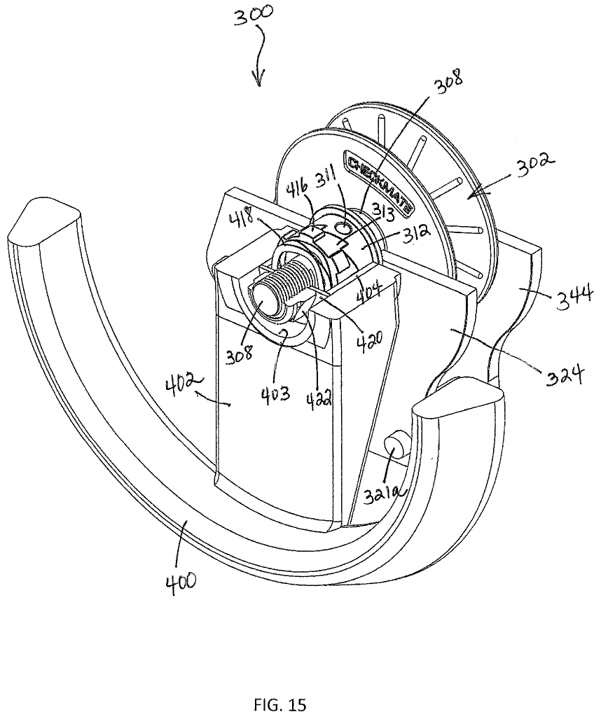

FIG. 15 is a perspective partial cross section view of a portion of the lifeline tensioner shown in FIG. 14.

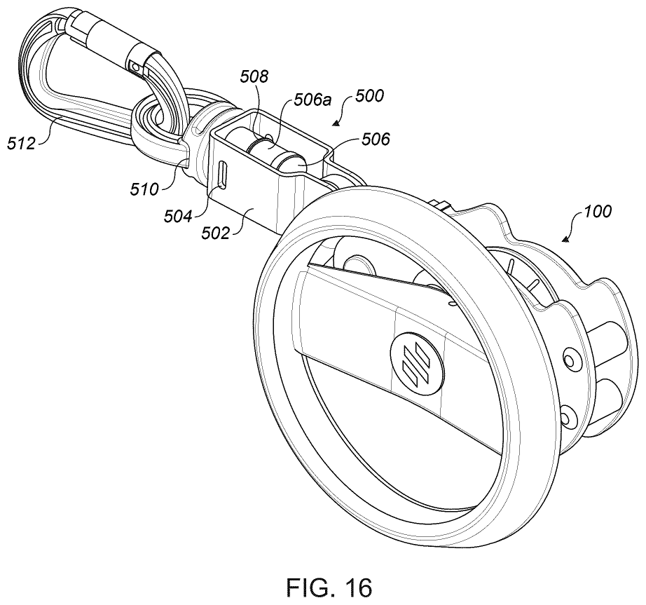

FIG. 16 is a perspective view of the lifeline tensioner shown in FIG. 1 attached to a tension indicator; and

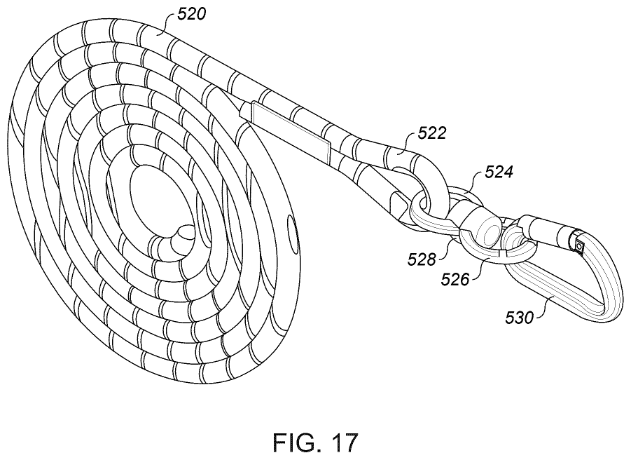

FIG. 17 is a perspective view of a lifeline including a swivel at its distal end.

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the components in the Figure(s) being described. Because components of embodiments can be positioned in a number of different orientations, the directional terminology is used for purposes of illustration and is in no way limiting. It is to be understood that other embodiments may be utilized.

Embodiments of the disclosure generally provide a lifeline tensioner for tensioning a lifeline of a horizontal lifeline assembly.

An embodiment lifeline tensioner 100 generally includes a pulley 102, a cam 156, and release arms 170 and 180 positioned between side plates 124 and 144. A wheel 200 is operatively connected to the side plate 124 and the pulley 102.

The pulley 102 includes a base 103 from which a first side 105 and a second side 106 extend laterally outward to form a lifeline channel 104 therebetween. The first and second sides 105 and 106 are angled to form a narrower portion proximate the base 103 and the inner surfaces include engaging members, such as radially extending ribs, which assist in engaging the lifeline during use. A shaft 108 extends longitudinally outward from the base 103 proximate each of the sides 105 and 106. Proximate the first side 105 the shaft 108 includes a bore 109 extending laterally therethrough. Although the pulley 102 is shown as an integral component, it is recognized that it could be made of several components operatively connected together.

The first side plate 124 includes a generally round main portion 125 from which a top lobe 127, a side extension 129, and a bottom 131 extend. The main portion 125 includes a central aperture 126, the top lobe 127 includes a top aperture 128, the side extension 129 includes a side aperture 130, and the bottom 131 includes first and second apertures 132 and 133 proximate each end of the bottom 131. The first side plate 124 could be made of any suitable material such as, but not limited to, aluminum.

Similarly, the second side plate 144 includes a generally round main portion 145 from which a top lobe 147, a side extension 149, and a bottom 151 extend. The main portion 145 includes a central aperture 146, the top lobe 147 includes a top aperture 148, the side extension 149 includes a side aperture 150, and the bottom 151 includes first and second apertures 152 and 153 proximate each end of the bottom 151. The second side plate 144 could be made of any suitable material such as, but not limited to, aluminum.

The cam 156 includes a main portion 157 from which a connector portion 159 and an engaging portion 161 extend. The main portion 157 includes a rounded portion 157a and a central aperture 158. The connector portion 159 includes an aperture 160. The engaging portion 161 includes an engaging surface with teeth 162. Although teeth 162 are shown, it is recognised that any suitable engaging member could be used.

The first release arm 170 includes a main portion 171 from which a first protrusion 173 extends upward from its top and an extension portion 175 extends outward and downward from its side. The main portion 171 includes an aperture 172, the first protrusion 173 includes an aperture 174, and the extension portion 175 includes an aperture 176.

Similarly, the second release arm 180 includes a main portion 181 from which a first protrusion 183 extends upward from its top and an extension portion 185 extends outward and downward from its side. The main portion 181 includes an aperture 182, the first protrusion 183 includes an aperture 184, and the extension portion 185 includes an aperture 186.

The wheel 200 includes a generally cylindrical rim 201 and a support 202 extends between opposing sides of the rim 201 within the center of the wheel 200. A middle portion of the support 202 includes a longitudinally extending bore 203 and an intersecting laterally extending bore 204.

To assemble the lifeline tensioner 100, the shaft 108 of the pulley 102 is inserted through an aperture 114 of an O-ring 113, through the central aperture 126 of the first side plate 124, and through the bore 203 of the wheel 200. The bore 109 of the shaft 108 aligns with the bore 204 of the support 202, and the pin 111 is inserted through the bores 204 and 109 to connect the pulley 102 to the wheel 200. A first extension 117a of a spacer 116 is inserted through aperture 130 of side extension 129, a first extension 119a of a spacer 118 is inserted through aperture 132 of bottom 131, and a first extension 121a of a spacer 120 is inserted through aperture 133 of bottom 131. Then, the second side plate 144 is connected by inserting the shaft 108 on the other side of the pulley 102 through the central aperture 146 of the second side plate 144, inserting the second extension 117b of spacer 116 through the aperture 150 of side extension 149, inserting the second extension 119b of spacer 118 through aperture 152 of bottom 151, and inserting the second extension 121b of spacer 120 through aperture 153 of bottom 151. Because the pulley 102 and the wheel 200 are operatively connected, they rotate about a first axis relative to the housing.

The shaft 194 is inserted through the aperture 128 of the first side plate 124, through the aperture 172 of the first release arm 170, through an aperture 165 of a first cam spacer 164, through the central aperture 158 of the cam 156, through an aperture 167 of a second cam spacer 166, through the aperture 182 of the second release arm 180, through the aperture 148 of the second side plate 144, through a bore 207 of a spacer 206, and through a bore 209 of a locking member such as a lock nut 208. Although a lock nut 208 is shown, it is recognised that other suitable locking members could be used. The lock nut 208 preferably adds friction among the release arms 170 and 180, the cam 156, and the side plates 124 and 144 and clamps the assembly together. A fastener 196 extends through the aperture 184 of the second release arm 180, through a bore 191 of a spacer 190, and through the aperture 174 of the first release arm 170. A fastener 197 extends through the aperture 186 of the second release arm 180, through a bore 189 of a spacer 188, and through the aperture 176 of the first release arm 170. The side plates 124 and 144 generally form a housing. The cam 156 and the release arm (formed by the first and second release arms 170 and 180) are rotatable about a second axis relative to the housing, shaft 194. The engaging portion 161 of the cam 156 is selectively positionable within the channel 104 and is configured and arranged to selectively secure a lifeline within the channel 104. The cam 156 has an engaging position and a releasing position. In the engaging position, the engaging portion 161 is positioned within the channel 104 to exert force upon the lifeline so that the lifeline can move in a first movement direction but not in a second movement direction opposite the first movement direction. In the releasing position, the engaging portion 161 is positioned to allow the lifeline to move in both the first and second movement directions relative to the pulley 102.

In operation for use with a horizontal lifeline assembly, the lifeline 210, which includes a first anchor end 211, an intermediate portion 212, and a second anchor end 213, is routed between the spacers 118 and 120, between the sides 105 and 106 of the pulley 102, between the pulley 102 and the engaging portion 161 of the cam 156, and between the spacers 116 and 118. In one example, the lifeline tensioner 100 is positioned proximate first anchor end 211. This is shown in FIG. 8. A carabiner 216 is inserted through the aperture 160 of the cam 156 and connected to a first anchorage structure, such as stanchion 220. The anchor end 213 is secured to a second anchorage structure, such as stanchion 221, via a carabiner 217 by means well known in the art, and the intermediate portion 212 generally extends between the lifeline tensioner 100 and the stanchion 221. This is shown in FIGS. 11 and 12.

To tension the lifeline 210, a user simply rotates the wheel 200. While rotating the wheel 200, the pin 111 transfers the torque from the wheel 200 to the pulley 102, thereby rotating the pulley 102. Because the lifeline 210 is captured within the lifeline channel 104, against the sides 105 and 106 by the engaging portion 161 of the cam 156, as the cam 156 rotates, the lifeline 210 is moved within the channel 104. The cam 156 is configured and arranged to allow passage of the lifeline 210 in a first movement direction but not in an opposite, second movement direction, thereby allowing the lifeline 210 to be tensioned while rotating the wheel 200 in a first rotation direction but, due to the engagement of the lifeline 210 and the tension in the lifeline 210, the lifeline 210 is not released when the wheel 200 is no longer being rotated in the first rotation direction. In other words, rotation of the wheel 200 in the first rotation direction rotates the pulley 102 in the first rotation direction thereby moving the lifeline 210 within the channel 104 in the first movement direction when the cam 156 is in the engaging position, and wherein the engaging portion 161 prevents movement of the lifeline 210 within the channel 104 in the second movement direction opposite the first movement direction when in the engaging position 161 thereby preventing rotation of the wheel 200 and the pulley 102 in the second rotation direction. As the amount of tension in the lifeline 210 increases, greater pressure is applied by the cam 156 because the carabiner 216 operatively connected to connector portion 159 pivots the engaging portion 161 toward the pulley 102 thereby applying greater pressure on the lifeline 210.

Preferably, the pitch circle diameter of the wheel is 178.25 mm +/−15%, the outer diameter of the wheel is 195.50 mm +/−15%, and the inner diameter is 178.25 mm +/−15%; and the pitch circle diameter of the pulley is 52.5 mm +/−15%, the outer diameter of the pulley is 76.0 mm +/−15%, and the inner diameter of the pulley is 30.0 mm +/−15%. Because the wheel 200 has a larger diameter than that of the pitch circle diameter of the pulley 102, there is a mechanical advantage so that the tension in the lifeline 210 will be an order of magnitude greater than what the user supplies. The wheel 200 provides an ergonomic surface, which can easily be gripped with two hands thereby allowing the user to stop the lifeline tensioner 100 from twisting around the axis of the lifeline 210.

To release the tension in the lifeline 210, the lock nut 208 is loosened to reduce friction among the release arms 170 and 180, the cam 156, and the side plates 124 and 144, and the user pivots the release arms 170 and 180 about the shaft 194 so that the extension portions 175 and 185 move away from the pulley 102. As the extension portions 175 and 185 move away from the pulley 102, the release arm spacer 190, which acts as an engaging member, contacts the connector portion 159 of the cam 156 thereby causing the cam 156 to also pivot about the shaft 194 so that the engaging portion 161 pivots away from the pulley 102. Because the cam 156 no longer engages the lifeline 210, the lifeline 210 may be moved in either direction within the channel 104 relative to the pulley 102 thereby allowing tension to be released for disassembly of the horizontal lifeline assembly.

An embodiment lifeline tensioner 300 shown in FIGS. 14 and 15 generally includes a pulley 302, a cam 356, and release arms 370 and 380 positioned between side plates 324 and 344. A wheel 400 is operatively connected to the side plate 324 and the pulley 302.

The pulley 302, similar to pulley 102, includes a base from which a first side and a second side extend laterally outward to form a lifeline channel therebetween. The first and second sides are angled to form a narrower portion proximate the base and the inner surfaces include engaging members, such as radially extending ribs, which assist in engaging the lifeline during use. A shaft 308 extends longitudinally outward from the base proximate each of the sides. Proximate the first side the shaft 308 includes a bore 309 extending laterally therethrough and the distal end is preferably threaded. Although the pulley 302 is shown as an integral component, it is recognised that it could be made of several components operatively connected together.

The first side plate 324 includes a generally round main portion 325 from which a top lobe 327, a side extension 329, and a bottom 331 extend. The main portion 325 includes a central aperture 326, the top lobe 327 includes a top aperture 328, the side extension 329 includes a side aperture 330, and the bottom 331 includes first and second apertures 332 and 333 proximate each end of the bottom 331. The first side plate 324 could be made of any suitable material such as, but not limited to, aluminum.

Similarly, the second side plate 344 includes a generally round main portion 345 from which a top lobe 347, a side extension 349, and a bottom 351 extend. The main portion 345 includes a central aperture 346, the top lobe 347 includes a top aperture 348, the side extension 349 includes a side aperture 350, and the bottom 351 includes first and second apertures 352 and 353 proximate each end of the bottom 351. The second side plate 344 could be made of any suitable material such as, but not limited to, aluminum.

The cam 356, similar to cam 156, includes a main portion from which a connector portion 359 and an engaging portion extend. The main portion includes a rounded portion and a central aperture. The connector portion 359 includes an aperture 360. The engaging portion includes an engaging surface with teeth. Although teeth are shown, it is recognised that any suitable engaging member could be used.

The first release arm 370 includes a main portion 371 from which a first protrusion 373 extends upward from its top and an extension portion 375 extends outward and downward from its side. The main portion 371 includes an aperture 372, the first protrusion 373 includes an aperture 374, and the extension portion 375 includes an aperture 376.

Similarly, the second release arm 380 includes a main portion 381 from which a first protrusion 383 extends upward from its top and an extension portion 385 extends outward and downward from its side. The main portion 381 includes an aperture 382, the first protrusion 383 includes an aperture 384, and the extension portion 385 includes an aperture 386.

The wheel 400 includes a generally cylindrical rim 401 and a support 402 extends between opposing sides of the rim 401 within the center of the wheel 400. A middle portion of the support 402 includes a longitudinally extending bore 403 in which a splined insert 404 including notches 405 is positioned. Preferably, the splined insert 404 is made of stainless steel, but any suitable material could be used.

To assemble the lifeline tensioner 300, the shaft 308 of the pulley 302 is inserted through the central aperture 326 of the first side plate 324 and through the bore 315 of the ratchet ring 312. The bore 309 of the shaft 308 aligns with the bore 314 of the ratchet ring 312, and the pin 311 is inserted through the bores 314 and 309 to connect the pulley 302 to the ratchet ring 312. The pin 311 prevents the ratchet ring 312 from rotating about the shaft 308. Then the shaft 308 is inserted through the bore 403 of the wheel 400 so that the teeth 313 of the ratchet ring 312 are positioned within the splined insert 404. The shaft 308 is then inserted through bore 417 of splined ratchet 415, through bore 419 of biasing member 418, through bore 421 of washer 420, and through threaded bore 423 of nut 422. The splined ratchet 415 is also positioned within the splined insert 404. The splined insert 404 includes notches 405 configured and arranged to receive extensions 416 of the splined ratchet 415 to prevent splined ratchet 415 from rotating about shaft 308. The splined ratchet 415 is configured and arranged to slide back and forth within the splined insert 404 along the shaft 308, and the biasing member 418 provides linear compressive tension against the splined ratchet ring 415. The biasing member 418 is held in place proximate the distal end of the shaft 308 with the washer 420 and the nut 422. An example of a nut that could be used is a M12 left-hand thread nyloc nut that threads onto the end of the left-hand thread of the shaft 308, but it is recognised that other suitable connectors could be used to hold the biasing member 418 in place on the shaft 308. A first extension 317a of a spacer 316 is inserted through aperture 330 of side extension 329, a first extension 319a of a spacer 318 is inserted through aperture 332 of bottom 331, and a first extension 321a of a spacer 320 is inserted through aperture 333 of bottom 331. Then, the second side plate 344 is connected by inserting the shaft 308 on the other side of the pulley 302 through the central aperture 346 of the second side plate 344, inserting the second extension 317b of spacer 316 through the aperture 350 of side extension 349, inserting the second extension 319b of spacer 318 through aperture 352 of bottom 351, and inserting the second extension 321b of spacer 320 through aperture 353 of bottom 351. Because the pulley 302 and the wheel 300 are operatively connected, they rotate about a first axis relative to the housing.

The shaft 394 is inserted through the aperture 328 of the first side plate 324, through the aperture 372 of the first release arm 370, through an aperture of a first cam spacer 364, through the central aperture of the cam 356, through an aperture of a second cam spacer 166, through the aperture 382 of the second release arm 380, through the aperture 348 of the second side plate 344, through a bore 407 of a spacer 406, and through a bore 409 of a locking member such as a lock nut 408. Although a lock nut 408 is shown, it is recognised that other suitable locking members could be used. The lock nut 408 preferably adds friction among the release arms 370 and 380, the cam 356, and the side plates 324 and 344 and clamps the assembly together. A fastener (not shown) extends through the aperture 384 of the second release arm 380, through a bore of a spacer 390, and through the aperture 374 of the first release arm 370. A fastener (not shown) extends through the aperture 386 of the second release arm 380, through a bore of a spacer 388, and through the aperture 376 of the first release arm 370. The side plates 324 and 344 generally form a housing. The cam 356 and the release arm (formed by the first and second release arms 370 and 380) are rotatable about a second axis relative to the housing, shaft 394. The engaging portion (similar to engaging portion 161) of the cam 356 is selectively positionable within the channel and is configured and arranged to selectively secure a lifeline within the channel. The cam 356 has an engaging position and a releasing position. In the engaging position, the engaging portion is positioned within the channel to exert force upon the lifeline so that the lifeline can move in a first movement direction but not in a second movement direction opposite the first movement direction. In the releasing position, the engaging portion is positioned to allow the lifeline to move in both the first and second movement directions relative to the pulley 302.

In operation for use with a horizontal lifeline assembly, the lifeline (shown in FIG. 17) is routed through the lifeline tensioner 300 similarly to how lifeline 210 is routed through lifeline tensioner 100, and the lifeline tensioner 300 is installed similarly to form part of a horizontal lifeline assembly.

To tension the lifeline, a user simply rotates the wheel 400. While rotating the wheel 400, the pin 311 transfers the torque from the wheel 400 to the pulley 302, thereby rotating the pulley 302. As the hand wheel 400 is rotated to apply tension to the rope lifeline, the mating faces or teeth 313 and 416a of ratchet ring 312 and the splined ratchet 415, respectively, slide against each other to force against the linear compressive tension of the biasing member 418. Splined ratchet 415 slides inside the splined insert 404 of the hand wheel 400 in the direction of the axis of the shaft 308 away from the pulley 302 until the ratchet ring 312 and spline ratchet 415 click back together on the next mating faces or teeth. The configuration of the mating faces or teeth allow rotation in one direction but not the opposite direction. Because the lifeline is captured within the lifeline channel, against the sides of the pulley 302 by the engaging portion of the cam 356, as the cam 356 rotates, the lifeline is moved within the channel. The cam 356 and the ratchet ring 312/ splined ratchet 415 are configured and arranged to allow passage of the lifeline in a first movement direction but not in an opposite, second movement direction, thereby allowing the lifeline to be tensioned while rotating the wheel 400 in a first rotation direction but, due to the engagement of the lifeline, the ratchet ring 312/splined ratchet 415, and the tension in the lifeline, the lifeline is not released when the wheel 400 is no longer being rotated in the first rotation direction. In other words, rotation of the wheel 400 in the first rotation direction rotates the pulley 302 in the first rotation direction thereby moving the lifeline within the channel in the first movement direction when the cam 356 is in the engaging position, and wherein the engaging portion prevents movement of the lifeline within the channel in the second movement direction opposite the first movement direction when in the engaging position thereby preventing rotation of the wheel 400 and the pulley 302 in the second rotation direction. In addition, due to the configuration of the mating faces or teeth of the ratchet ring 312 and the splined ratchet 415, rotation is allowed in the first rotation direction but not in the second rotation direction. Therefore, both the cam 356 and the ratchet ring 312/splined ratchet 415 allow rotation in the first rotation direction but not in the second rotation direction. As the amount of tension in the lifeline increases, greater pressure is applied by the cam 356 because the carabiner operatively connected to connector portion 359 pivots the engaging portion toward the pulley 302 thereby applying greater pressure on the lifeline. Preferably, the pitch circle diameter of the wheel is 178.25 mm +/−15%, the outer diameter of the wheel is 195.50 mm +/−15%, and the inner diameter is 178.25 mm +/−15%; and the pitch circle diameter of the pulley is 52.5 mm +/−15%, the outer diameter of the pulley is 76.0 mm +/−15%, and the inner diameter of the pulley is 30.0 mm +/−15%. Because the wheel 400 has a larger diameter than that of the pitch circle diameter of the pulley 302, there is a mechanical advantage so that the tension in the lifeline will be an order of magnitude greater than what the user supplies. The wheel 400 provides an ergonomic surface, which can easily be gripped with two hands thereby allowing the user to stop the lifeline tensioner 300 from twisting around the axis of the lifeline.

To release the tension in the lifeline, the lock nut 408 is loosened to reduce friction among the release arms 370 and 380, the cam 356, and the side plates 324 and 344, and the user pivots the release arms 370 and 380 about the shaft 394 so that the extension portions 375 and 385 move away from the pulley 302. As the extension portions 375 and 385 move away from the pulley 302, the release arm spacer 390, which acts as an engaging member, contacts the connector portion 359 of the cam 356 thereby causing the cam 356 to also pivot about the shaft 394 so that the engaging portion pivots away from the pulley 302. The shaft 308 is pulled outward away from the hand wheel 400 so that the mating faces or teeth of ratchet ring 312 and splined ratchet 415 are no longer in engagement. Because the cam 356 no longer engages the lifeline, and because the ratchet ring 312 and splined ratchet 415 are no longer in engagement, the lifeline may be moved in either direction within the channel relative to the pulley 302 thereby allowing tension to be released for disassembly of the horizontal lifeline assembly.

FIG. 16 shows a further embodiment of the invention. In this embodiment, the lifeline tensioner 100 described hereinabove is connected to a tension indicator 500. The tension indicator 500 comprises an indicator housing 502 which defines therein a window 504. Housed within the indicator housing 502 is an indicator element 506 which comprises an inner component (not shown), an outer component 506a and a spring (not shown). The outer component 506a is capable of displacement relative to the inner component against the restorative force of the spring. The inner component is fixed to the indicator housing 502 and the outer component passes through an aperture defined by the indicator housing 502 and is coupled to a connector 510. The connector 510 is connected to a carabiner 512, which in turn is connected to an anchor substrate in use.

As the lifeline tensioner 100 is tensioned as described above, the connector 510 urges the distal end of the outer component 506a out of the indicator housing 502. When the correct tension has been applied to the lifeline, an indicator band 508 carried by the outer component 506a will align with the window 504. When the indicator band 508 is visible in the window 504, the user knows that the correct tension has been applied to the lifeline.

The skilled person will appreciate that the tension indicator may indicate different tensions. Additionally, the desired tension may be varied by varying the spring disposed within the indicator element 506.

FIG. 18 shows a yet further embodiment of the invention. In this embodiment, a lifeline 520 is provided. The lifeline 520 may be used with any of the embodiments of the lifeline tensioner described hereinabove. The lifeline 520 defines at one end a closed loop 522. Such closed loops are well known in the art of lifelines and it needs not be described in more detail herein. Coupled to the closed loop 522 is a first part 524 of a swivel coupling. A second part 526 of the swivel coupling is rotationally coupled to the first part 524 via a rotational coupling 528. Again, such swivels are well known in the art. A carabiner 530 is connected to the second part 526 of the swivel. The carabiner 530 is connected to an anchor substrate in use. The swivel coupling between the distal end of the lifeline 520 and the anchor substrate prevents the lifeline from kinking or twisting when in use and tensioned. The skilled person will appreciate that a lifeline should be in a non-twisted and non-kinked configuration in use.

Although specific embodiments have been illustrated and described herein, it will be appreciated by those of ordinary skill in the art that a variety of alternate and/or equivalent implementations may be substituted for the specific embodiments shown and described within the scope of the present invention as claimed.

1. A lifeline arrangement comprising a lifeline and a tensioner for the lifeline, wherein the lifeline tensioner includes: a housing; a pulley disposed within the housing, wherein the pulley is connected to a drive shaft and rotation of the drive shaft results in rotation of the pulley, the pulley defines a circumferential channel, and the drive shaft and pulley rotate relative to the housing about a first axis; a portion of the lifeline is located within a portion of the circumferential channel; a lifeline locking element including a lifeline engagement portion and an anchor portion, wherein the lifeline engagement portion has an engaged configuration in which it engages a portion of the lifeline within the circumferential channel, and a release configuration in which it is spaced from the lifeline, the lifeline engagement portion in its engaged configuration permits displacement of the lifeline in a tensioning direction, but prevents displacement of the lifeline in a loosening direction, and a connector is connected to the anchor portion; and wherein an operating wheel is connected to the drive shaft.

2. A lifeline arrangement according to claim 1, wherein the drive shaft extends through a portion of the housing and the operating wheel is located externally of the housing.

3. A lifeline arrangement according to claim 1, wherein the operating wheel is connected to the drive shaft via a clutch, wherein rotation of the operating wheel in a first direction causes the drive shaft to rotate and rotation of the operating wheel in a second, opposite direction causes the operating wheel to rotate relative to the drive shaft.

4. A lifeline arrangement according to claim 3, wherein the clutch is a two-part clutch, wherein a first part of the clutch is rotationally fixed to the drive shaft and a second part of the clutch is rotationally fixed to the operating wheel; and wherein the second part of the clutch engages the first part of the clutch when the operating wheel is rotated in the first direction, and wherein the second part of the clutch slips relative to the first part of the clutch when the operating wheel is rotated in the second direction.

5. A lifeline arrangement according to claim 4, wherein at least one of the first and second parts of the clutch define teeth, wherein each of the teeth has an engagement face and a sloped slip face.

6. A lifeline arrangement according to claim 1, wherein the lifeline tensioner further includes a release element coupled to the lifeline locking element, wherein displacement of the release element causes the lifeline locking element to move from its engaged configuration to its release configuration.

7. A lifeline arrangement according to claim 1, wherein the anchor portion connector is configured to be secured to an anchor structure.

8. A lifeline arrangement according to claim 1, wherein a tensile force applied to the anchor portion urges the lifeline engagement portion into its engaged configuration.

9. A lifeline arrangement comprising a lifeline and a tensioner for the lifeline, wherein the lifeline tensioner includes: a housing; a pulley disposed within the housing, wherein the pulley is connected to a drive shaft and rotation of the drive shaft results in rotation of the pulley, the pulley defines a circumferential channel, and the drive shaft and pulley rotate relative to the housing about a first axis; a portion of the lifeline is located within a portion of the circumferential channel; a lifeline locking element including a lifeline engagement portion and an anchor portion, wherein the lifeline engagement portion has an engaged configuration in which it engages a portion of the lifeline within the circumferential channel, and a release configuration in which it is spaced from the lifeline, the lifeline engagement portion in its engaged configuration permits displacement of the lifeline in a tensioning direction, but prevents displacement of the lifeline in a loosening direction, and a connector is connected to the anchor portion; and wherein a tension indicator is located between the connector and the anchor portion, wherein the tension indicator senses a tensile force applied to the lifeline and indicates if the sensed tensile force is within a pre-determined range.

10. A lifeline arrangement according to claim 9, wherein the tension indicator includes a spring having a fixed end and a free end and the free end of the spring is displaced relative to the fixed end as a result of the tensile force within the lifeline.

11. A lifeline arrangement according to claim 10, wherein the tension indicator includes an indicator arm which is displaced with the free end of the spring.

12. A lifeline arrangement according to claim 9, wherein the lifeline tensioner further includes a release element coupled to the lifeline locking element, wherein displacement of the release element causes the lifeline locking element to move from its engaged configuration to its release configuration.

13. A lifeline arrangement according to claim 9, wherein the anchor portion connector is configured to be secured to an anchor structure.

14. A lifeline arrangement according to claim 9, wherein a tensile force applied to the anchor portion urges the lifeline engagement portion into its engaged configuration.

15. A lifeline arrangement comprising a lifeline and a tensioner for the lifeline, wherein the lifeline tensioner includes: a housing; a pulley disposed within the housing, wherein the pulley is connected to a drive shaft and rotation of the drive shaft results in rotation of the pulley, the pulley defines a circumferential channel, and the drive shaft and pulley rotate relative to the housing about a first axis; a portion of the lifeline is located within a portion of the circumferential channel; a lifeline locking element including a lifeline engagement portion and an anchor portion, wherein the lifeline engagement portion has an engaged configuration in which it engages a portion of the lifeline within the circumferential channel, and a release configuration in which it is spaced from the lifeline, the lifeline engagement portion in its engaged configuration permits displacement of the lifeline in a tensioning direction, but prevents displacement of the lifeline in a loosening direction, and a connector is connected to the anchor portion; and wherein a distal end of the lifeline includes a swivel.

16. A lifeline arrangement according to claim 15, wherein the swivel includes a lifeline connector portion which is coupled to the distal end of the lifeline, and a lifeline anchor portion which is adapted to be secured to an anchor structure; wherein the lifeline connector portion and the lifeline anchor portions together define a longitudinal axis; and wherein the lifeline connector portion is rotatably coupled to the lifeline anchor portion such that the lifeline connector portion is capable of rotating relative to the lifeline anchor portion about the longitudinal axis.

17. A lifeline arrangement according to claim 15, wherein the lifeline tensioner further includes a release element coupled to the lifeline locking element, wherein displacement of the release element causes the lifeline locking element to move from its engaged configuration to its release configuration.

18. A lifeline arrangement according to claim 15, wherein the anchor portion connector is configured to be secured to an anchor structure.

19. A lifeline arrangement according to claim 15, wherein a tensile force applied to the anchor portion urges the lifeline engagement portion into its engaged configuration.
